(19) United States
(12) Patent Application Publication
(10) Pub. No.: US 2024/0200781 A1
(43) Pub. Date: Jun. 20, 2024

(54) WOOD HEATING DEVICE

(71) Applicant: ATELIER DOMINIQUE IMBERT, Viols le Fort (FR)

(72) Inventors: Laurent GABORIT, Clapiers (FR); Jean-Marc CHALIER, Aspiran (FR); Dominique IMBERT, Viols le Fort (FR)

(21) Appl. No.: 18/555,596

(22) PCT Filed: Apr. 13, 2022
(86) PCT No.: PCT/EP22/59841

§ 371 Date: Oct. 16, 2023

(30) Foreign Application Priority Data
Apr. 16, 2021 (FR) 2103979

(51) Int. Cl. F24B 1/19; F24B 5/02

(52) U.S. Cl. CPC F24B 1/1902; F24B 5/023

(57) ABSTRACT

The wood heating device, such as a stove or a wood-burner, includes a combustion chamber defined by a metal combustion space having an intake. The chamber is equipped with a closing mechanism of the retractable type, and at least one distinct oxidant air inlet orifice. The combustion space is housed in a metal outer casing. The outer casing defines with the combustion space at least one reserve of preheated air and an oxidant air duct. An outside-air supply opening is made in the outer casing and is arranged laterally to the intake. The reserve of preheated air bypasses the combustion space by at least one side starting from the outside-air supply opening.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a wood heating device such as a stove or wood-burner, and more particularly belongs to the field of wood hearths.

### 2. Description of Related Art Including Information Disclosed Under 37 CFR 1.97 and 37 CFR 1.98

Currently, iconic decorative fireplaces with a suspended hearth exist. Such fireplaces consist, on the one hand, of an open hearth which has an elegant aesthetic form, and, on the other hand, a flue gas discharge duct connected to the open hearth. The discharge duct also acts as an element for suspending the hearth relative to a support that is usually formed by a ceiling. However, certain models of these decorative fireplaces have a hearth of particular shape, such as an oblate shape.

It should be noted that document EP 2923152 describes a device for improving combustion in a fireplace of usual shape with an open or closed hearth. In this respect, this device comprises a channel integrating a heat exchanger wherein air ducts extend. The bed of embers is consumed on the andiron, and the air circulates by natural convection within the ducts and is heated by transfer of heat energy from the bed of embers to the ducts. The oxidant air is thus preheated before being released by vertical ducts located at the rear of the hearth, which improves combustion. The device described by document EP 2923152 is specifically designed to adapt this system to a chimney of usual shape with an open or closed hearth.

There are also adjustable air intake devices arranged on closed or suspended hearths to a wall. In this respect, document FR 2944585 describes an adjustable air intake device with inward angle arranged frontally in the lower part of the frame of a glazed door. This air intake device comprises a strip mounted movable in a slide of the glazed door. The slide is closed by a counter-tab provided with openings. The air flow passes through apertures located at the bottom of the frame of the glazed door, then in the cut-outs of the strip, before being returned perpendicularly to the air inlet sections towards the inside of the hearth via the openings.

The document FR 2835043 proposes a device allowing the elongation of the flue gas path in the throat of a closed hearth. Thus, the throat comprises a flat deflector comprising two orifices located on either side of a coping located below opposite the rear part of the flat deflector. The lateral positioning of the orifices generates a curved circulation of the combustion flue gases before they pass through the outlet. The elongation of the path of the flue gases exchanging over the walls of the throat therefore makes it possible to reduce the flue gas temperatures. The combustion efficiency of a closed wood hearth is therefore optimized. Nevertheless, this document chooses to treat the exhaust flue gases and not the oxidant air entering the combustion chamber of the wood hearth.

### BRIEF SUMMARY OF THE INVENTION

The present invention aims to improve the efficiency of such wood heating devices, in particular by bringing the pre-heated oxidant air into the combustion chamber of that device.

To this end, the present invention relates to a wood heating device, such as a stove or a wood-burner, comprising a combustion chamber delimited by a metal combustion space comprising an intake, equipped with closing means of the retractable type, and at least one distinct oxidant air inlet orifice, said combustion space being housed in a metal outer casing, the outer casing comprising a front opening coinciding with the intake of the combustion space, at least one oxidant air duct being provided between the outer casing and the combustion space from the at least one oxidant air inlet orifice and at least one outside-air supply opening comprised by the outer casing.

More particularly, at least one oxidant air duct and at least one reserve of preheated air are preferably provided between the outer casing and the combustion space, the reserve of preheated air extending from the outside-air supply opening to an end of the oxidant air duct, the oxidant air duct extending from said end to the oxidant air inlet orifice, the reserve of preheated air being delimited at least in part by an internal wall of the outer casing and by an outer wall of the combustion chamber, the reserve of preheated air bypassing the combustion space by at least one side from the outside-air supply opening.

A technical advantage arising from the present invention consists in that by raising the preheated air stored within a reserve of preheated air surrounding the combustion chamber, and by circulating the oxidant air on an extended path extending from said reserve of preheated air through a duct that conveys the oxidant air to the inlet orifice of the enclosed space, the interior space within this space rises more quickly in temperature. This configuration also allows the combustion chamber to reach higher temperatures.

In addition, the reserve of preheated air formed around the combustion space, and upstream thereof, constitutes an air stock brought to high temperatures even before it enters the combustion hearth. Preferably, the fresh air inlet adjustment flap, or FAI adjustment, takes the oxidant air directly into said reserve, so that the oxidant air collected by the FAI adjustment flap is pre-heated.

Such a configuration makes it possible to greatly reduce the variability of the temperature within the combustion chamber relative to the flow rate of outside air entering the outside-air supply opening.

The faster, higher temperature rise within the combustion chamber, combined with a less significant variability in this temperature rise relative to the incoming outside-air flow rate, allow a reduction in the discharges of harmful particles. The environmental performance of the heating device is greatly improved.

Advantageously, at least one outside-air supply opening is located at the height of the front opening of the outer casing.

Advantageously, the reserve of preheated air bypasses the combustion chamber by at least one side, starting from the outside-air supply opening, and preferably by both sides, left and right.

According to one possible feature, the combustion chamber comprises a rear part located diametrically opposite the intake, the reserve of preheated air extending to said rear part.

According to one possible additional feature, the heating device comprises a fresh air inlet adjustment flap configured to regulate an air inlet within the combustion space, the fresh air inlet adjustment flap being in fluid communication with the preheated air reserve and furthermore being in fluid communication with the oxidant air duct.

According to one possible additional feature, the oxidant air inlet orifice is placed downstream of the fresh air inlet adjustment flap, the “downstream” direction being defined according to the direction in which air circulates from the outside-air supply opening.

According to one possible additional feature, the fresh air inlet adjustment flap is distinct from the outside-air supply opening, being offset from the outside-air supply opening. One advantage associated with this configuration is that it is possible to constitute a stock of preheated air downstream of the air supply opening, said stock of air being able to supply the FAI adjustment flap and thus to supply the combustion chamber with oxidant air that is already preheated.

According to one possible additional feature, the fresh air inlet adjustment flap is close to the end of the oxidant air duct or located at said end of the oxidant air duct.

According to another possible feature of the invention, the reserve of preheated air extends at least partially around the combustion space and/or above the latter.

According to one possible feature of the invention, the outside-air supply opening is delimited at least in part by the front opening of the outer casing and at least in part by the combustion chamber.

According to another possible feature of the invention, the reserve of preheated air extends at least partially around the combustion space from an outside-air supply opening arranged laterally to the intake to at least one oxidant air inlet orifice.

According to one possible feature of the invention, the reserve of preheated air extends on either side, laterally to the combustion space from outside-air supply openings arranged laterally on either side of said intake of the combustion space.

According to one possible additional feature of the invention, the oxidant air duct extends partially above the combustion space.

According to another possible feature of the invention, the at least one oxidant air inlet orifice into the combustion space is located substantially above the intake.

According to another possible feature, the oxidant air duct comprises a baffle configured to extend an outside air flow circuit within said duct.

According to an additional possible feature, the inner wall of the outer casing is located immediately opposite the outer wall of the combustion space. The heating device then does not comprise an intermediate wall inserted between said inner wall of the outer casing and said outer wall of the combustion space.

According to one possible additional feature of the invention, the closing means of the retractable type are defined by at least one flap pivotably or slidably mounted on the combustion space in order, in the closed position, to close the intake. In particular, at least one closure flap may comprise a glazed wall.

### BRIEF DESCRIPTION OF THE SEVERAL VIEWS OF THE DRAWINGS

Other features and advantages will appear in the following detailed description which follows, corresponding to a non-limiting example embodiment of the invention, this example being shown by the attached FIGS. 1 to 4.

FIG. 1 is a schematic perspective view of a wood heating device according to the invention.

FIG. 2 is a schematic perspective view of this same device, the upper part of the outer casing having been removed.

FIG. 3 is a schematic vertical cross-sectional view of the same wood heating device.

FIG. 4 is a representation of the same heating device, seen from below in perspective, on which some internal elements of the device are also shown.

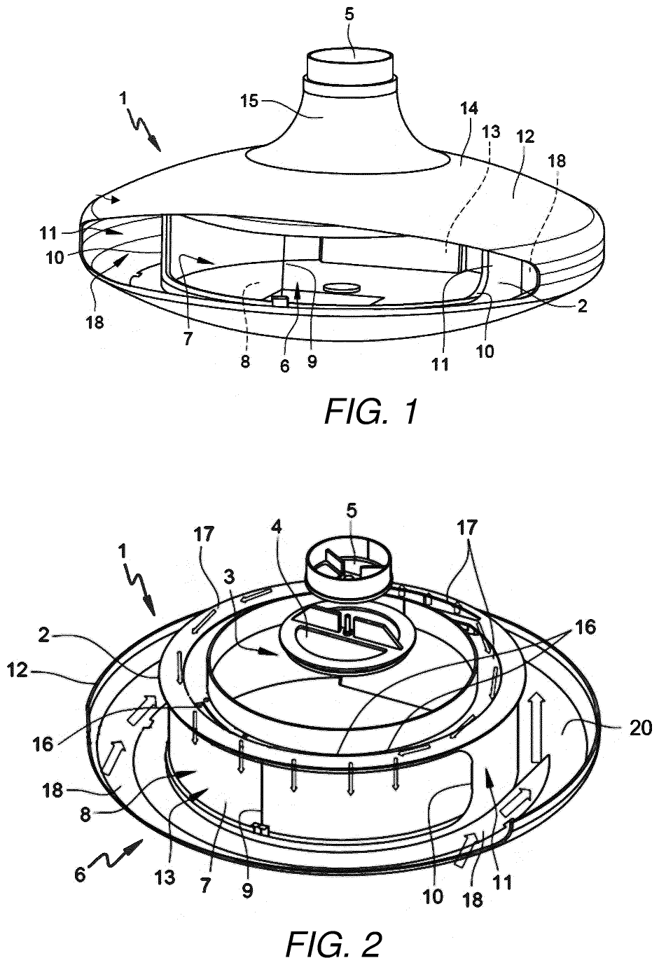

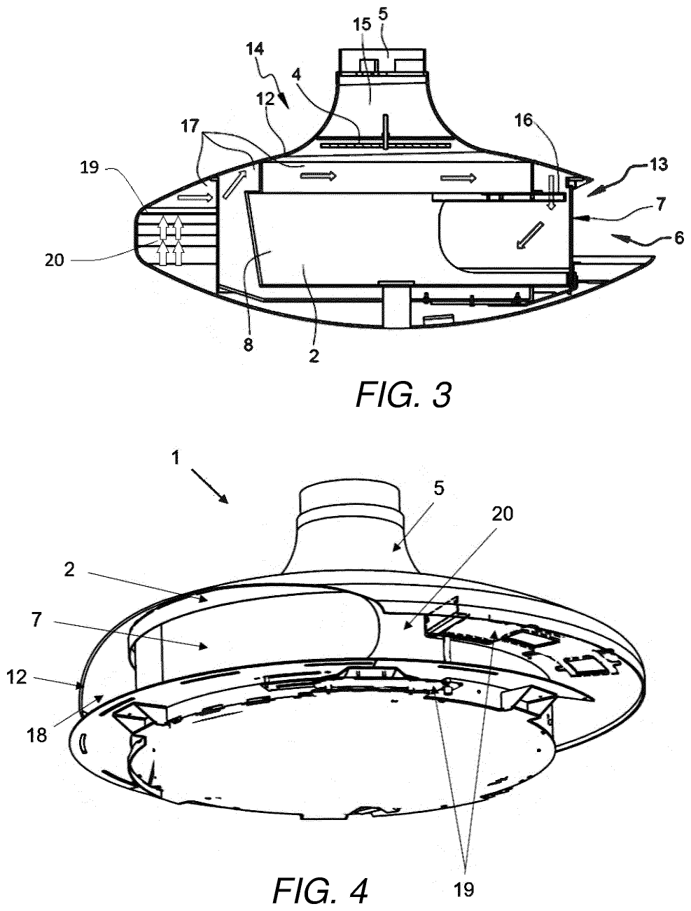

### DETAILED DESCRIPTION OF THE INVENTION

As shown in the figures of the attached drawings, the present invention relates to a wood heating device 1 which can take the form of a stove or as more particularly shown as a wood-burner.

More particularly, this wood heating device 1 essentially comprises a combustion space 2 of the metal type which can take various embodiments. It may be of circular or parallelepiped cross-section. It is preferably closed at the upper part by a dome 3 at which there is provided a flue gas outlet opening 4 intended to communicate with a combustion flue gas discharge duct 5.

This combustion space 2 comprises, in particular in its front part 6, an intake 7 making it possible to access the combustion chamber 8 delimited by the combustion space 2.

In particular, this intake 7 allows the combustion space 2 to be loaded with fuel, in this case wood. This intake 7 is equipped with closing means 9 of the retractable type. By way of example, these closing means 9 can take the form of a closure flap pivotably mounted about a vertical axis at one of its lateral ends 10, at the lateral edge 11 of said intake 7. According to another embodiment, this flap can be slidably mounted on the outer wall of the combustion space 2 defined, for example, with a substantially cylindrical cross-section. This flap, also of convex shape, can, depending on the case, extend in front of the intake 7 and close the latter or laterally retract, leaving free access to the combustion chamber 8.

In a preferred configuration, the closing means 7 are defined by two convex flaps slidably mounted on the combustion space 2 with substantially cylindrical section 2 for, depending on the case, closing the intake 7 or retracting by sliding on either side thereof so as to free access to the combustion chamber 8.

Advantageously, such a flap defining the closing means 9 is glazed at least partially, facilitating vision in the combustion space 2.

According to the invention, the combustion space 2 is housed in an outer casing 12 also of metal type, which comprises a front opening 13 coinciding with the intake 7. In its upper part 14, this outer casing 12 defines a throat 15 above the flue gas outlet opening 4 of the combustion space 2. The combustion flue gas discharge duct 5 can be connected to this throat 15.

The combustion space 2 is also provided with at least one oxidant air inlet orifice 16. The latter can be installed all around this combustion space 2. However, according to an advantageous embodiment, the oxidant air inlet orifice 16 emerges in the combustion chamber 8, above the intake 7. An associated advantage is to form a descending oxidant air curtain.

According to the invention, between the outer casing 12 and the combustion space 2 extends a reserve of preheated air 20, capable of storing heated oxidant air from which the combustion enclosure 2 is subsequently supplied through the oxidant air inlet orifice(s) 16. The outside air is admitted into the reserve of preheated air 20 via at least one outside-air supply opening 18.

The reserve of preheated air 20 thus forms an air storage volume able to rise in temperature, around the combustion space 2. The outer casing 12 of the heating device itself extends around said reserve of preheated air 20. The reserve of preheated air 20 is preferably delimited radially at least in part by the inner wall of the outer casing 12 and by the outer wall of the combustion space 2.

Optionally and advantageously, as is the case in the present example, an oxidant air duct 17 further extends between the outer casing 12 and the combustion space 2. The circulation of the oxidant air is then carried out in the oxidant air duct 17. The duct 17 here extends between a duct inlet, which is in fluid communication with the reserve of preheated air 20, and the oxidant air inlet orifice(s) 16.

The oxidant air duct 17 can thus supply the combustion space 2 with oxidant air, which has previously been preheated within the reserve 20.

Advantageously, the oxidant air duct 17 is delimited radially at least in part by the inner wall of the outer casing 12 and the outer wall of the combustion space 2.

Such a duct can, however, take the form of a tubular profile extending between these walls of the outer casing and the combustion space.

Such a duct 17 provides the advantage of bringing into the combustion chamber 8 of the space 2 previously preheated oxidant air drawn from the reserve of preheated air 20, considerably improving the combustion and therefore the efficiency of the heating device 1.

This duct 17 thus communicates on the one hand with this or these oxidant air inlet orifices 16, and on the other hand with the reserve of preheated air 20.

According to a preferred embodiment, the outside-air supply opening 18 is arranged at the front opening 13 of the outer casing 12. The outside-air supply opening 18 is more particularly delimited at least in part by this front opening 13 and at least partially by the combustion space 2. The outside-air supply opening 18 is then placed at the front of the heating device 1.

According to a preferred embodiment, an outside-air supply opening 18 is provided at least one lateral edge 11 of the intake 7, advantageously at each of the side edges 11 of the intake 7.

The duct 17 meets an oxidant air inlet orifice 16 on the one hand, and the reserve of preheated air 20 on the other hand, which itself joins the outside-air supply opening 18. The duct 17 preferably extends at least partially around the combustion space 2 and/or above the combustion space 2.

In the present example, the duct 17 and the reserve of preheated air 20 bypass the combustion space 2 by at least one side, preferably by the left side and the right side.

Preferably, the reserve of preheated air 20 comprises a first portion that rotates on either side of the space 2, and the duct 17 comprises a second portion passing through the top of the combustion space 2, until reaching the oxidant air inlet orifice(s) 16 provided for example, as in the example described here and shown, above the intake 7.

Preferably and in accordance with the embodiment corresponding to the attached drawings, the reserve of preheated air 20, starting from at least one air supply opening 18 at the side edge 11 of the intake 7, bypasses the combustion space 2 by joining a rear part thereof.

The oxidant air duct 17 preferably extends from a duct inlet that is in fluid communication with the reserve of preheated air 20, and preferably above the combustion space 2, until reaching the oxidant air inlet orifice(s) 16. As indicated above, the oxidant air inlet orifice(s) 16 are for example located above the intake 7.

More particularly, the rear part of the combustion space 2 is here diametrically opposite the front part 6 of the enclosure. It is advantageous for the reserve of preheated air 20 to extend from the outside-air supply opening 18, located in the front, to this rear part of the enclosure. Thus, the path of the incoming air is extended, which allows greater temperature rise of the oxidant air during its storage. In addition, the volume available in the reserve of preheated air is increased.

Still in accordance with this same preferred embodiment, the heating device 1 thus comprises a first left-hand storage portion of preheated air and a second right-hand reserve portion of preheated air (the “left” and “right” directions being identified relative to the intake 7), both of which are external air supply openings 18 at each of the side edges 11 of the intake 7, to bypass, on either side, the combustion space 2 and reach the rear part thereof.

According to another feature of the invention, at least one baffle can be provided in the oxidant air duct 17 to extend the circuit of the external air flow around the combustion space 2 and between it and the outer casing 12.

As can be seen in the view of the attached FIG. 4, the heating device 1 preferably comprises at least one fresh air inlet adjustment flap 19, commonly called “FAI adjustment” in the technical field of the design of heating devices, configured to regulate an air inlet within the combustion space 2. The reserve of preheated air 20 and the duct 17 are in fluid communication with the fresh air inlet adjustment flap 19. Thus, the fresh air inlet adjustment flap 19 is able to draw preheated air stored in the reserve of preheated air 20, and to supply this preheated air to the duct 17 as an oxidant air for the supply of the combustion chamber.

Advantageously, the oxidant air inlet orifice 16 is placed downstream of the fresh air inlet adjustment flap 19. According to an additional feature, the fresh air inlet adjustment flap 19 is distinct from the outside-air supply opening 18, being offset from said outside-air supply opening 18. Also preferably, the fresh air inlet adjustment flap 19 is not located at the front of the device, but rather on a lateral part (as shown in FIG. 4) or on a rear part. Here, the fresh air inlet adjustment flap 19 is located in the lateral portion of the reserve of preheated air 20, which bypasses the enclosure 2 on either side.

The fresh air inlet adjustment flap 19 is preferably located at an intermediate position between the reserve of preheated air 20 and the oxidant air duct 17. According to one possible example, the fresh air inlet adjustment flap 19 is close to an inlet of the duct 17 or is located at an inlet of the oxidant air duct 17.

An advantage associated with this configuration is that it is possible not only to constitute a stock of preheated oxidant air downstream from the outside-air supply opening 18, but also to supply the FAI adjustment with this heated oxidant air. The rise in temperature within the combustion space 2 is thus considerably increased, compared to existing devices where the FAI adjustment would be close to or combined with the outside-air supply opening and where the air supplied to the FAI adjustment would not be preheated. Another technical advantage is to reduce the variability of the temperature rise in the furnace, with respect to the flow rate of outside air entering the device.

The heating device 1 can be designed to be suspended through the discharge duct 5. It can also be rotatably mounted around this discharge duct 5.

For reminder, this heating device can take various embodiments such as spherical, parallelepiped, oblate or ovoid.

We claim:

1. A wood heating device, comprising:
a combustion chamber delimited by a metal combustion space, having an intake, equipped with closing means of the retractable type, and
at least one distinct oxidant air inlet orifice, said combustion space being housed in a metal outer casing,
wherein the outer casing comprises a front opening coinciding with the intake of the combustion space and comprises at least one outside-air supply opening arranged laterally to the intake,
wherein at least one oxidant air duct and at least one reserve of preheated air are provided between the outer casing and the combustion space,
wherein the reserve of preheated air extending from the outside-air supply opening to an end of the oxidant air duct, the oxidant air duct extending from said end to the oxidant air inlet orifice, the reserve of preheated air being delimited at least in part by an internal wall of the outer casing and by an outer wall of the combustion space, and
wherein the reserve of preheated air bypassing the combustion space by at least one side starting from the outside-air supply opening.

2. The wood heating device, according to claim 1, wherein the combustion space comprises a rear part located diametrically opposite the intake, the reserve of preheated air extending to said rear part.

3. The wood heating device, according to claim 1, wherein a fresh air inlet adjustment flap configured to regulate an air inlet within the combustion space, the fresh air inlet adjustment flap being in fluid communication with the reserve of preheated air and being in fluid communication with the oxidant air duct.

4. The wood heating device, according to claim 3, wherein the oxidant air inlet orifice is placed downstream of the fresh air inlet adjustment flap, in the direction in which air circulates from the outside-air supply opening.

5. The wood heating device, according to claim 3, wherein the fresh air inlet adjustment flap is offset relative to the outside-air supply opening.

6. The wood heating device, according to claim 3, wherein the fresh air inlet adjustment flap is located at the end of the oxidant air duct.

7. The wood heating device, according to claim 1, wherein the oxidant air duct extends partially above the combustion space.

8. The wood heating device, according to claim 1, wherein the outside-air supply opening is delimited at least in part by the front opening of the outer casing and at least partially by the combustion space.

9. The wood heating device, according to claim 1, wherein the reserve of preheated air extends on either side and laterally to the combustion space, from outside-air supply openings arranged laterally on either side of said intake of the combustion space.

10. The wood heating device, according to claim 1, wherein the at least one oxidant air inlet orifice opens into the combustion chamber, above the intake.

11. The wood heating device, according to claim 1, wherein the inner wall of the outer casing is located immediately opposite the outer wall of the combustion space, the heating device having no intermediate wall inserted between said inner wall of the outer casing and said outer wall of the combustion space.

12. The wood heating device, according to claim 1, wherein the closing means are defined by at least one closure flap pivotably or slidably mounted on the combustion space to close the intake in the closed position.

13. The wood heating device, according to claim 12, wherein at least one closure flap comprises a glazed wall.
